(19) United States
(12) Patent Application Publication
(10) Pub. No.: US 2018/0191885 A1
(43) Pub. Date: Jul. 5, 2018

(54) SPEAKERPHONE WITH BUILT-IN SENSORS

(71) Applicant: Crestron Electronics, Inc., Rockleigh, NJ (US)

(72) Inventors: Joseph Sarrasin, Redding, CT (US); Daniel Jackson, Valhalla, NY (US)

(73) Assignee: Crestron Electronics, Inc., Rockleigh, NJ (US)

(21) Appl. No.: 15/398,227

(22) Filed: Jan. 4, 2017

(51) Int. Cl. H04M 1/60; H04N 7/15; H04N 7/14; G06K 9/00

(52) U.S. Cl. CPC H04M 1/6033; H04N 7/15; H04N 7/147; H04M 2250/52; G06K 9/00288; H04M 2250/12; H04M 2201/50; G06K 9/00255

(57) ABSTRACT

A speakerphone continuously detects, monitors, and recognizes occupants in a conference room. The speakerphone switches between a sleep state and a powered state. The sleep state is a state whereby the speakerphone is not fully functioning and thereby is saving energy. The powered state is a state whereby the speakerphone is fully functioning. The speakerphone is comprised of at least one passive infrared sensor to generate a first signal based on sensed infrared radiation; at least one audio sensor to receive a second signal; and a processor coupled to the at least one passive infrared sensor and at least one audio sensor. The processor detects the presence of the first signal and in response to the detection of the first signal, the processor activates the speakerphone to a powered state. However, in response to the non-detection of the first signal, the processor activates the speakerphone device to a sleep state.

### BACKGROUND OF THE INVENTION

### Technical Field

The present invention relates to video conferencing and more specifically to a speakerphone with built-in sensors.

### Background Art

Video conferencing allows groups of people separated by large distances to have conferences and meetings. In some examples, two parties will each use a teleconferencing system that includes endpoint devices. An example of an endpoint device is a speakerphone used to enable telephonic communication between the two parties. The speakerphone may include a dial-pad for one party to call the other party at a given time. One party may initiate the call by pressing a call button on the dial-pad. At the conclusion of the meeting, one party may end the call by manually pushing the hang up or end button on the dial-pad. As such, the speakerphone turns on and off in response to the manual initiation and end of the call. However, at the end of the meeting, one party may accidentally not end the call and walk out of the conference room. Given current concerns about energy costs, there is a need to improve power consumption. Additionally, a traditional speakerphone is not able to recognize the parties at the meeting including the meeting organizer. As such, the parties have to introduce themselves on the call. Sensors are an important component in overcoming the deficiencies of traditional speakerphones.

Sensors are a common component in many buildings. Typically mounted on ceilings, for example, occupancy sensors detect the presence of occupants within an area. They are most commonly used to control the power delivered to electrical loads, specifically lights, depending on the occupancy of the monitored area. For example, an occupancy sensor may be used to turn off a light in an office when occupancy has not been sensed for a period of time, thereby conserving electricity. Conversely, the occupancy sensor may conveniently turn on the light upon sensing occupancy after a period of vacancy.

Accordingly, there is now a need for an improved speakerphone device with sensors to continuously detect, monitor, and identify occupants in a conference room. There also is a need for a speakerphone device that can automatically initiate and end a call based on the detection of the occupants.

### SUMMARY OF THE INVENTION

It is an object of the embodiments to substantially solve at least the problems and/or disadvantages discussed above, and to provide at least one or more of the advantages described below.

It is therefore a general aspect of the embodiments to provide a speakerphone that can continuously detect, monitor, and recognize occupants in a conference.

It is therefore a general aspect of the embodiments to provide a speakerphone that can automatically initiate and end a call based on the detection of occupants.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

### DISCLOSURE OF INVENTION

According to one aspect of the embodiments, a speakerphone device comprises at least one passive infrared sensor to generate a first signal based on sensed infrared radiation. The speakerphone device further comprises at least one audio sensor to generate a second signal based on detecting sound in a conference room. A processor is coupled to the at least one passive infrared sensor and the at least one audio sensor to detect the presence of the first signal. In response to receiving the first signal by the processor, the processor is configured to activate the speakerphone device to a powered state, the powered state is a state whereby the speakerphone device is fully functioning. However, in response to not receiving the first signal by the processor, the processor is configured to activate the speakerphone device to a sleep state, the sleep state is a state whereby the speakerphone device is not fully functioning and thereby is saving energy.

According to another aspect of the embodiments, a method is provided for generating a first signal based on sensed infrared radiation by at least one passive infrared sensor; generating a second signal based on detecting sound in a conference room by at least one audio sensor; coupling a processor to the at least one passive infrared sensor and the at least one audio sensor; and detecting by the processor the presence of the first signal. In response to receiving the first signal, activating a speakerphone device to a powered state, the powered state is a state whereby the speakerphone device is fully functioning. However, in response to not receiving the first signal, activating the speakerphone device to a sleep state, the sleep state is a state whereby the speakerphone device is not fully functioning and thereby is saving energy.

### BRIEF DESCRIPTION OF DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

### BRIEF DESCRIPTION OF THE SEVERAL VIEWS OF THE DRAWING

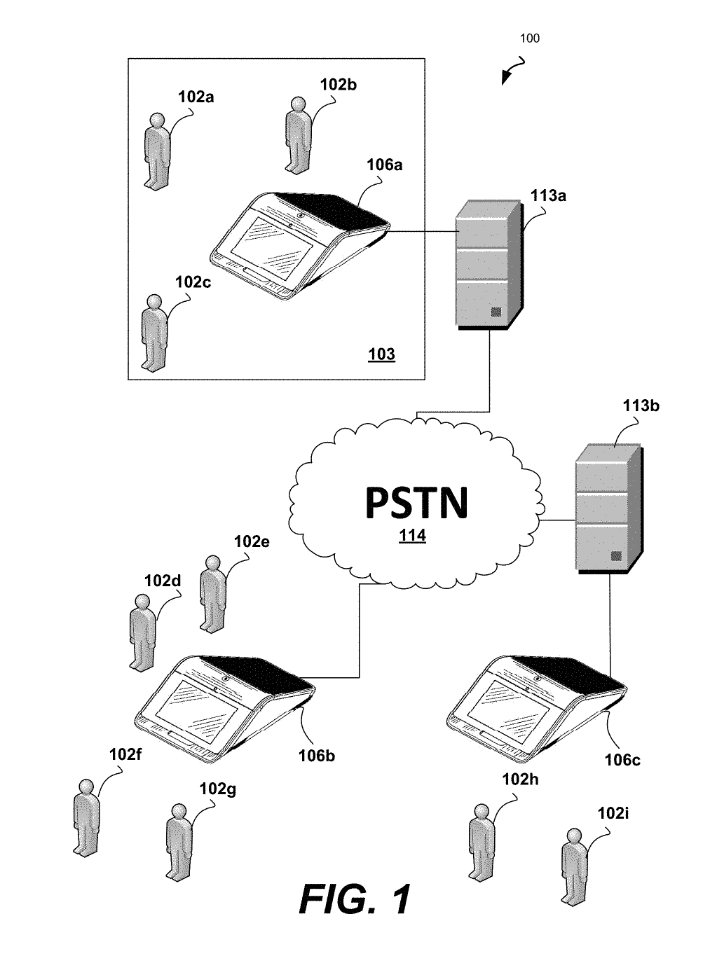

FIG. 1 is a block diagram depicting multiple conference rooms, each conference room includes a speakerphone device, according to an illustrative embodiment of the invention.

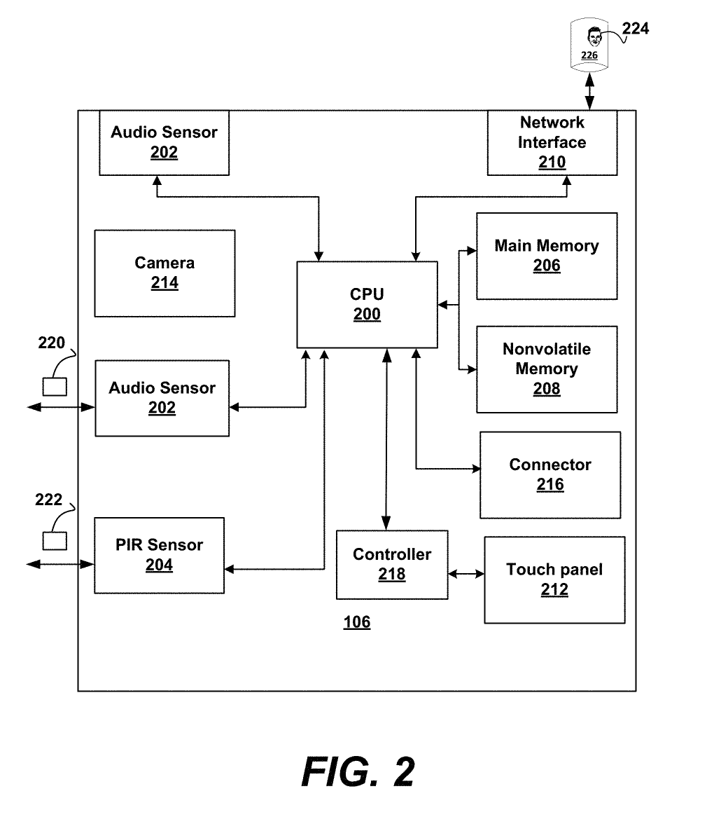

FIG. 2 is a block diagram of the speakerphone device with sensors, according to an illustrative embodiment of the invention.

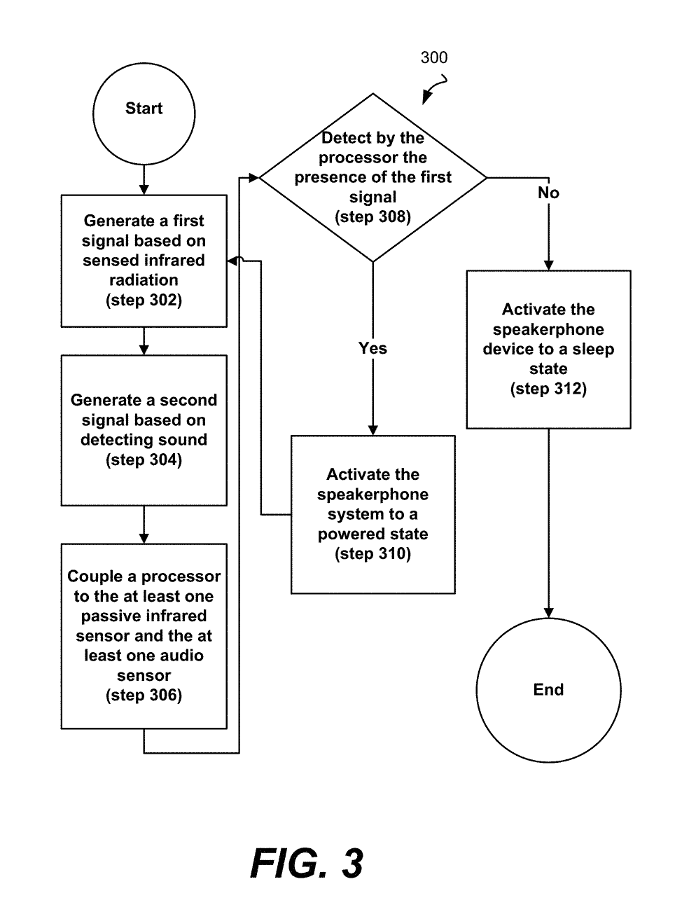

FIG. 3 is a flowchart showing a process for switching between a sleep state and a powered state, according to an illustrative embodiment of the invention.

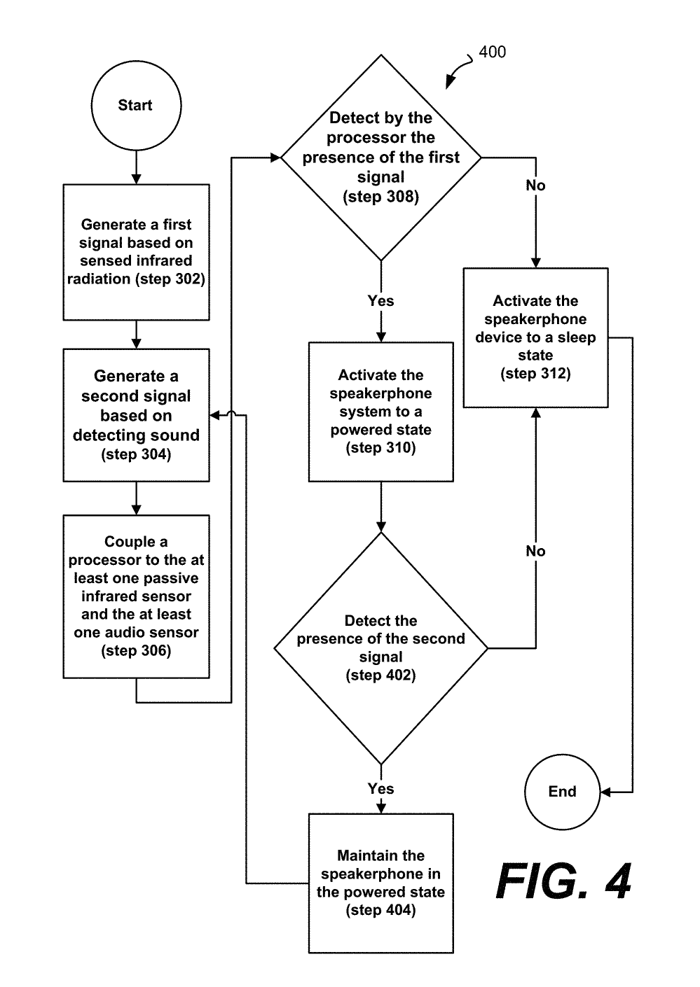

FIG. 4 is a flowchart showing another process for switching between a sleep state and a powered state, according to another illustrative embodiment of the invention.

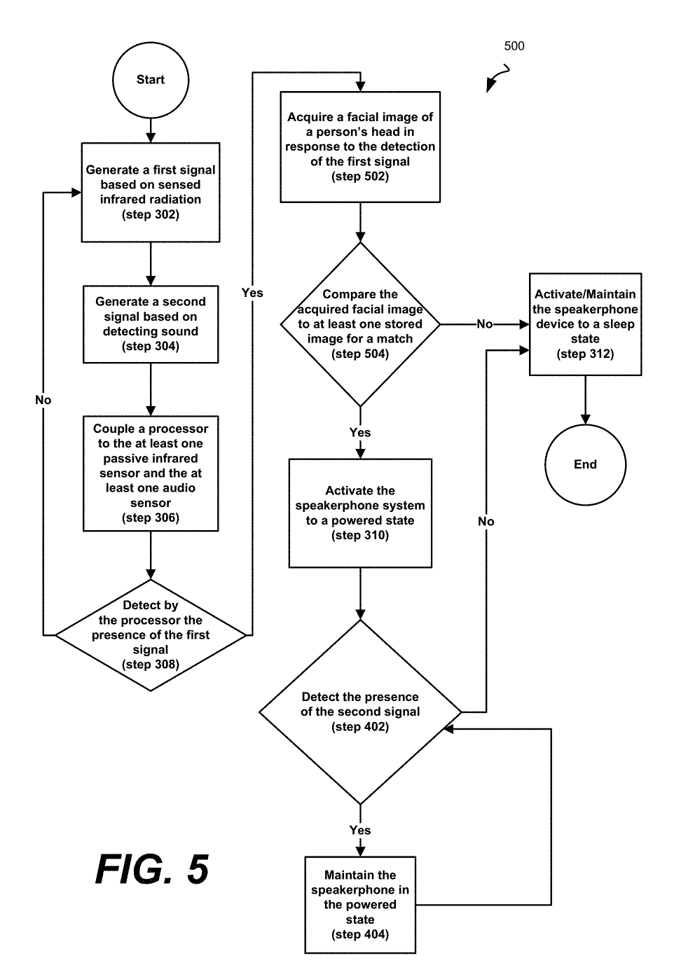

FIG. 5 is a flowchart showing a process for switching between a sleep state and a powered state utilizing facial recognition, according to yet another illustrative embodiment of the invention.

### DETAILED DESCRIPTION OF THE INVENTION

The embodiments are described more fully hereinafter with reference to the accompanying drawings, in which embodiments of the inventive concept are shown. In the drawings, the relative size of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices disclosed herein.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE ELEMENTS IN THE DRAWINGS IN NUMERICAL ORDER

The following is a list of the major elements in the drawings in numerical order.
100 Teleconferencing system
102a, b, c . . . i (collectively, 102) Participant(s)
103 Office or conference room
104a, 104b, 104c (collectively, 104) Location(s)
106a, 106b, 106c (collectively 106) Conferencing or speakerphone device
113a, 113b (collectively, 113) Private branch exchange (PBX)
114 Public network
200 Central processing unit (CPU)
202 Audio sensor
204 Passive infrared sensor (PIR)
206 Main memory
208 Nonvolatile storage
210 Network interface
212 Touch panel
214 Camera
216 Connector
218 Touch panel controller
220 First signal
222 Second signal
224 Participant's facial image
226 Database
300 Flowchart of a method of switching between a sleep state and a powered state
302 Step of generating a first signal
304 Step of receiving a second signal
306 Step of coupling a processor to the PIR sensor
308 Step of detecting the first signal
310 Step of activating the speakerphone to a powered state
312 Step of activating the speakerphone to a sleep state
400 Flowchart of a method of switching between a sleep state and a powered state
402 Step of detecting the second signal
404 Step of maintaining the speakerphone in a powered state
500 Flowchart of a method of switching between a sleep state and a powered state using facial recognition
502 Step of acquiring a facial image
504 Step of comparing the acquired image to a stored image for a match

### List of Acronyms Used in the Specification in Alphabetical Order

The following is a list of the acronyms used in the specification in alphabetical order.

### ASICS Application Specific Integrated Circuits

### CPU Central Processing Unit

### DB Decibel Level

### HDMI High-Definition Multimedia Interface

### IP Internet Protocol

### PBX Private Branch Exchange

### PIR Passive Infrared Sensor

PoE Power over Ethernet

### PSTN Public Switched Telephone Network

### RISC Reduced Instruction Set

### ROM Read-Only Memory

### USB Universal Serial Bus

### MODE(S) FOR CARRYING OUT THE INVENTION

The present embodiments provide devices and methods to continuously detect, monitor, and identify occupants in a conference room. More specifically, the present invention provides a speakerphone with built-in sensors to enable the speakerphone device to switch in-between a powered state and a sleep state in response to detecting and monitoring occupants in a conference room.

Referring to FIG. 1, in a teleconferencing system 100, participants 102a, 102b, 102c . . . 102i gather in an office or conference room 103 and are seated at various endpoint locations 104a, 104b, 104c. The endpoint locations 104a, 104b, 104c may be remote to each other, e.g., conference rooms on opposite ends of a building, on different floors, in different cities, in different countries, etc. At each location 104a, 104b, 104c the participants 102a, 102b, 102c . . . 102i utilize a conferencing unit or speakerphone device 106a, 106b, 106c (collectively, 106) to communicate from one endpoint location to another endpoint location 104a, 104b, 104c. The speakerphone device 106 may be connected through a communications server, e.g., a private branch exchange (PBX) 113a, 113b (collectively, 113), to a public network 114, e.g., a public switched telephone network (PSTN) or a data network such as the Internet.

FIG. 2 is an illustrative block diagram of a conferencing unit or speakerphone device 106 according to an illustrative embodiment of the invention. In one embodiment, the speakerphone device 106 is a table top speakerphone with integrated touch panel 212. The speakerphone device 106 includes at least one central processing unit (CPU) 200. For example, the CPU 200 may represent one or more microprocessors, and the microprocessors may be “general purpose” microprocessors, a combination of general and special purpose microprocessors, or application specific integrated circuits (ASICs). Additionally or alternatively, the CPU 200 may include one or more reduced instruction set (RISC) processors, video processors, or related chip sets. The CPU 200 may provide processing capability to continuously detect, monitor, and identify participants 102 from one or more sensor inputs such as audio sensor 202 and passive infrared sensor (PIR) 204. The CPU 200 is configured to continuously detect, monitor, and identify participants within an office or conference room 103. The CPU 200 can place the speakerphone device 106 in a sleep state or powered state. In a sleep state, the speakerphone device 106 is capable of performing certain activities such as keeping memory refreshed or periodically waking up upon, for example, the PIR sensor 204 detecting radiation from a participant 102; however the speakerphone device 106 does not perform to its full capability. The sleep state may include any of the following including, but not limited to, disconnecting the speakerphone device 106 from a call, not lighting up a touch panel 212, and not displaying various options on the touch panel 212.

The CPU 200 may be communicably coupled to a main memory 206, which may store data and executable code. The main memory 206 may be implemented using one or more types of machine-readable media capable of storing data. The main memory 206 may represent volatile memory such as RAM, and also may include nonvolatile memory, such as read-only memory (ROM) or Flash memory. In buffering or caching data related to operations of the CPU 200, the main memory 206 may store data associated with applications running on the speakerphone device 106.

In an embodiment, the speakerphone device 106 includes nonvolatile storage 208. The nonvolatile storage 208 may represent any suitable nonvolatile storage medium, such as a hard disk drive or nonvolatile memory, such as Flash memory. Being well-suited to long-term storage, the nonvolatile storage may store data files and software (e.g., for implementing functions on the speakerphone device 106).

The speakerphone device 106 further may include at least one PIR sensor 204 coupled to the CPU 200. The PIR sensor 204 measures infrared light radiating from objects such as a participant 102 in its field of view. The field of view generally is in front of a touch panel 212 of the speakerphone device 106. The PIR sensor 204 generates a first signal 220 based on sensed infrared radiation.

The speakerphone device 106 further may include at least one audio sensor 202, such as a microphone, coupled to the CPU 200 for sensing audio in a conference room 103. The at least one audio sensor 202 detects sound in the conference room 103. The sound may come from a participant 102 or the speakerphone device 106. A person on the other line may come through on the speakerphone device 106. In response to the audio sensor 202 detecting sound in the conference room (either from a participant 102 in the conference room 103 or another participant 102 coming through on the speakerphone device 106), the audio sensor 202 may generate a second signal 222. The audio sensor 202 coupled with the processor 200 may be set to generate a second signal 222 upon the audio sensor 202 detecting sound at a certain threshold. The processor 200 and audio sensor 202 determine whether the second signal 222 meets a minimum threshold as a requirement to maintaining the speakerphone device 106 in a powered stated. Such minimum threshold may be 60-70 decibel level (db) in the conference room 103. Further the threshold may involve not only the db level but also a timing threshold, which measures how long the audio has been above the db level. For example, the timing threshold may be 0.5 seconds. For example, the speakerphone device is in the powered state when (1) the sound level is at least, for example, 60 db and (2) the timing threshold is at least half a seconds. In an embodiment of the invention, the audio sensor 202, such as a microphone, provides a measure of audible sound in the conference room 103 and may be employed to qualify PIR detection. For example, in certain applications, detection of sounds in the conference room 103 may be required before the occupancy state is determined. Additionally, the second signal 222 can be used to prolong the occupancy state once it is established.

The speakerphone device 106a further comprises a network interface 210. The network interface 210 communicates to another speakerphone device 106b. In one embodiment, the network interface 210 is an RS485 wired connection. In a further embodiment, the network interface 210 is a power over Ethernet (PoE) interface for receiving electric power as well as for sending and receiving signals over an Internet Protocol (IP) based network to another speakerphone device 106.

The speakerphone device 106 further includes a touch panel controller 218 that is coupled to a touch panel 212 and CPU 200. The speakerphone device 106 uses the touch panel 212 to display various features such as a dial-pad and a room schedule. The touch panel 212 provides easier methods to dial into conference call by providing access into the room's calendar (e.g., room 103) for dialing as well as access to a company's directory directly on the speakerphone device 106. The speakerphone communicates with a database 226 via a network interface 210 to obtain room schedule and room reservation information such as the organizer's name, meeting calendar, and time and date of the meeting. Another feature of the speakerphone device 106 that is displayed on the touch panel 212 is the ability to view upcoming calendars and room connectivity information. The touch panel 212 can accept input in different ways. For example, capacitive touchscreens detect touch input when an object (e.g., a fingertip or stylus) distorts or interrupts an electrical current running across the surface. Touch panel 212 also could detect using optical sensors.

The CPU 200 may be coupled to a connector 216. The connector 216 can be comprised of one or more physical ports or connectors, such as HDMI (input and output), DisplayPort, USB, Bluetooth, and Ethernet. The connector 216 also can support various accessories such as microphone accessory pod (not shown).

In an embodiment, the speakerphone device 106 may use facial recognition techniques to identify or verify the participants 102 including the meeting organizer. The speakerphone device 106 captures participant's facial image 224 using a camera 214. The captured image 224 is then compared to a database of facial images stored in a database such as main memory 206 or another database 226 via the network interface 210 to determine a match and identification of the participant 102 including the meeting organizer.

FIG. 3 is a flowchart 300 of a method of switching between a sleep state and a powered state of a speakerphone device 106 as further described below. In operation, the speakerphone device 106 is initially in a sleep state. The sleep state is when the speakerphone device 106 is in low power or standby mode, thereby conserving power. Certain features will not be enabled in the standby or sleep mode. For example, the touchscreen 212 would not light up in the standby or sleep mode. A participant 102, such as the meeting organizer, would come into the conference room 103 and sits in front of the speakerphone device. In step 302, the PIR sensor 204 of the speakerphone device 106 generates a first signal 220 based on sensed infrared radiation from an area that is facing the touch panel 212 of the speakerphone device 106 to capture the participant 102 sitting in front of the speakerphone device 106. An audio sensor 202 of the speakerphone device 106 detects sound from the conference room 103 such as the participants 102, if any. In one embodiment, there are two audio sensors 202 coupled to the CPU 200 of the speakerphone device 106. The combination of the two audio sensors 202 monitor and detect audio from a participant 102 in the conference room 103. The audio sensors 202 can detect sound in the conference room 103 such as when a participant 102 is talking and either walking around the conference room 103 or sitting at a conference table. In step 304, at least one audio sensor 202 generates a second signal 222.

Continuing on in FIG. 3, in step 306, the CPU 200 is coupled to the PIR sensor 204 and audio sensor 202. In step 308, the CPU 200 detects whether the PIR sensor 204 detects the presence of the first signal 220 (e.g., presence of a participant 102 in front of the speakerphone device 106). In step 310, in response to detecting the sensed infrared radiation (e.g., first signal 220), the CPU 200 activates the speakerphone device 106 from a sleep state to a powered state. The powered state is a state in which the speakerphone device 106 is fully functioning. The features of the speakerphone device 106 are enabled. For example, the touchscreen lights up and the participant 102 is able to use the dial-pad. The participant 102 may use the speakerphone device 106 to, for example, dial into a conference call or use any other features that are available to the participant 102. Once the speakerphone device 106 is enabled, it stays in the enabled state (or powered state) as long as the processor 200 via the PIR sensor 204 senses infrared radiation from the participant 102 in front of the touch panel 212.

In step 312, if the PIR sensor 204 of the speakerphone 106 does not detect the presence of the first signal 220 (e.g., there is no participant 102 in front of the speakerphone device 106), the processor 200 of the speakerphone device 106 stays in the sleep state or if the speakerphone device 106 is in a powered state, the processor 200 deactivates the speakerphone device 106 from the powered state to a sleep state. In one embodiment, the speakerphone device 106 stays in the powered state for a period of time, for example, five minutes, after the speakerphone device 106 no longer receives the first or second signal 220, 222. Upon the expiration of the time period, the speakerphone device 106 may automatically switch to a sleep state to conserve power. The speakerphone device 106 utilizes the PIR sensor 204 and audio sensor 202 to continuously detect and monitor participants 102 in a conference room 103.

FIG. 4 is a flowchart 400 of another embodiment of a method of switching between a sleep state and a powered state that is similar to FIG. 3, with the exception of the descriptions below. One or more participant 102 initially comes in the conference room 103 and dials into a meeting. The PIR sensor 204 detects the presence of the participant 102 since he/she dials into the meeting. The participant 102 may leave his/her seat. In this case, the audio sensor 202 detects sound coming from the participant 102 in the conference room 103. The participant 102 may be standing using a white board (not shown) while speaking in the conference room 103. To capture this scenario, in step 402 of FIG. 4, the speakerphone device 106 detects the presence of a second signal 222 in the conference room 103. The second signal 222 is the detection of audio in the conference room 103, such as from one or more of the participant's voice, for example, a participant in front of the white board. In step 404, if there is a detection of the presence of the second signal 222, the speakerphone device 106 maintains in the powered state. The speakerphone device 106 stays in the powered state until the audio sensor 202 no longer detects the presence of the second signal 222 in the conference room 103.

However, if the audio sensor 202 does not detect the presence of the second signal 222 in the conference room 103, in step 312 the speakerphone device 106 switches from a powered state to a sleep state. In alternative embodiments, the speakerphone device 106 stays in the enabled state for a period of time, for example, five minutes after the speakerphone device 106 no longer receives the second signal 222. This could occur, for example, when participants 102 in the conference room 103 are silence. Upon the expiration of the time period, the speakerphone device 106 switches to a sleep state.

By using a combination of audio and PIR sensors 204, 206, the speakerphone device 106 is in a powered state only when it is being utilized. Sometimes, people in general may come into a conference room 103 and not utilize the speakerphone device 106. For example, two people may come into the conference 103 for a discussion. They may use a white board for the discussion. In this scenario, the speakerphone device 106 would be in a sleep state unless the person is in front of the touch panel 212; however, most people would not go in front of the speakerphone device 106 unless he/she has intention of using it. Further, the voice coming from the people would not switch the speakerphone device 106 from a sleep state to a powered state by the audio sensor 202 since, in this example, the audio sensor 202 waits until the PIR sensor 204 activates the speakerphone device 106 to a powered state first. In other embodiments, in step 402, the audio sensor 202 may detect sound coming from a participant 102 at another location coming through the speakerphone device 106. In this case, even though a participant 102 in the conference room 103 is not speaking, the speakerphone device 106 would remain in the powered state because sound is coming from another participant 102 in another conference room 103 coming through the speakerphone device 106. In other embodiments, in step 312, the speakerphone device 106 may automatically disconnect from a conference call when the speakerphone device 106 is in a sleep state. In another embodiment, the speakerphone device 106 may not disconnect from a conference call when it is in a sleep state but rather, the touch panel 212 may not be lit up thereby saving power.

FIG. 5 is a flowchart 500 of another embodiment of the speakerphone device 106 in which the speakerphone device 106 utilizes a facial recognition feature. The facial recognition feature, for example, ensures that participants 102 that are invited to the meeting can utilize the speakerphone device 106 thereby preventing a non-participant from utilizing the speakerphone device 106. In an embodiment, a participant 102 comes into a conference room 103 and is in front of the touch panel 212 of the speakerphone device 106. In step 302, the PIR sensor 204 of the speakerphone device 106 generates a first signal 220 based on sensed infrared radiation of a participant in front of the touch panel 212 of the speakerphone device 106. In step 304, the audio sensor 202 receives a second signal 222. In step 306, the processor 200 is coupled to the PIR sensor 204 and audio sensor 202. In step 308, the processor 200 detects whether the PIR sensor 204 detects the presence of the first signal 220 (e.g., presence of a participant 102 in front of the speakerphone device 106). In step 502, in response to detecting the sensed infrared radiation (e.g., first signal 220), the processor 200 utilizes the camera 214 to acquire a facial image 224 of the participant's head. In step 504, the speakerphone device 106 compares the acquired facial image 224 to at least one stored image in a database 226 for determining a match. In step 310, if there is a match, the speakerphone device 106 switches from a sleep state to a powered state. If there is no match, the speakerphone device 106 remains in the sleep state.

In step 402, the speakerphone device 106 detects the presence of the second signal 222 in the conference room 103. In this step, the speakerphone device 106 detects if there is any sound in the conference room 103 such as from any of the participants. In step 404, if there is sound, the speakerphone device 106 stays in the powered state. If there is no sound, in step 312, the speakerphone device 106 switches to a sleep state. In alternative embodiments, before switching to the sleep state, the speakerphone device 106 may wait for a certain period of time, for example, five minutes, before the speakerphone device 106 switches to a sleep state.

### INDUSTRIAL APPLICABILITY

The disclosed embodiments provide a device and a method for switching between a sleep state and a powered state. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative, rather than restrictive, in all respects of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

In addition, the various methods described above are not meant to limit any aspect of the embodiments, or to suggest that aspect of the embodiments should be implemented following the described methods. The purpose of the described methods is to facilitate the understanding of one or more aspects of the embodiments and to provide the reader with one or many possible implementations of the processes discussed herein. The steps performed during the described methods are not intended to completely describe the entire process but only to illustrate some of the aspects discussed above. It should be understood by one of ordinary skill in the art that the steps may be performed in a different order and that some steps may be eliminated or substituted.

### Alternate Embodiments

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

For example, any of the flow diagrams described herein may be modified or arranged in any manner to support operation in various configurations. The flow diagrams may include more or fewer blocks, combined or separated blocks, alternative flow arrangements, or the like. The flow diagrams also may be implemented in the form of hardware, firmware, or software. If implemented in software, the software may be written in any suitable code in accordance with the example embodiments herein or other embodiments. The software may be stored in any form of computer readable medium and loaded and executed by a general purpose or application specific processor suitable to perform the example embodiments described herein or other embodiments.

1-18. (canceled)

19. A tabletop conferencing device comprising:
a display adapted to display conferencing information;
a passive infrared sensor adapted to generate a signal based on sensed infrared radiation in a field of view, wherein the field of view consists of a front of the display of the tabletop conferencing device;
an audio sensor adapted to generate a signal based on detecting sound within a monitored area, wherein the detected sound within the monitored area comprises at least one of sound emitted from at least one of a participant in the monitored area and sound emitted by the tabletop conferencing device of a distal participant;
at least one processor coupled to the passive infrared sensor and the audio sensor, the at least one processor adapted to:
maintain the tabletop conferencing device in a sleep state until receiving a signal from the passive infrared sensor;
in response to receiving the signal from the passive infrared sensor while in the sleep state, switch the tabletop conferencing device from the sleep state to an enabled state;
maintain the tabletop conferencing device in the enabled state while receiving signals from the audio sensor;
in response to no longer receiving signals from the audio sensor while in the enabled state, switch the tabletop conferencing device to the sleep state.

20. The tabletop conferencing device of claim 19, wherein the at least one processor is further adapted to:
in response to receiving a signal from the audio sensor while in the sleep state, maintain the tabletop conferencing device in the sleep state.

21. The tabletop conferencing device of claim 20, wherein the at least one processor is further adapted to:
in response to no longer receiving signals from the passive infrared sensor while in the enabled state, maintain the tabletop conferencing device in the enabled state.

22. The tabletop conferencing device of claim 19, wherein the processor ignores signals from the audio sensor while in the sleep state.

23. The tabletop conferencing device of claim 19, wherein the at least one processor is further adapted to:
determine whether the signals received from the audio sensor exceed a minimum level threshold in order to maintain the tabletop conferencing device in the enabled state.

24. The tabletop conferencing device of claim 23, wherein the at least one processor is further adapted to:
determine whether the signals received from the audio sensor exceed the minimum level threshold over a minimum timing threshold.

25. (canceled)

26. The tabletop conferencing device of claim 19, further comprising:
a camera adapted to capture a facial image of a participant;
wherein the at least one processor is further adapted to:
compare an acquired facial image received from the camera to at least one stored image;
in response to determining a match between the acquired facial image and at least one stored image while the tabletop conferencing device is in the sleep state, switch the tabletop conferencing device from the sleep state to the enabled state.

27. The tabletop conferencing device of claim 26, wherein the at least one stored image comprises at least one of an image of a meeting organizer and an image of a meeting invitee.

28. The tabletop conferencing device of claim 19, wherein the sleep state comprises a low power state.

29. The tabletop conferencing device of claim 19, wherein the sleep state comprises a standby mode.

30. The tabletop conferencing device of claim 19, wherein the at least one processor determines that it is no longer receiving signals from the audio sensor by determining that it has not received a signal from the audio sensor for a predetermined period of time.

31. A tabletop conferencing device comprising:
a display adapted to display conferencing information;
a passive infrared sensor adapted to generate a signal based on sensed infrared radiation in a field of view, wherein the field of view consists of a front of the display of the tabletop conferencing device;
an audio sensor adapted to generate a signal based on a detected sound within a monitored area, wherein the detected sound within the monitored area comprises at least one of sound emitted from at least one of a participant in the monitored area and sound emitted by the tabletop conferencing device of a distal participant;
at least one processor coupled to the passive infrared sensor and the audio sensor, the at least one processor adapted to:
while the tabletop conferencing device is in a sleep state, monitor the field of view for presence detected by the passive infrared sensor, and switch the tabletop conferencing device to an enabled state upon receiving a signal from the passive infrared sensor; and
while the tabletop conferencing device is in the enabled state, monitor the monitored area for presence detected by the audio sensor, maintain the tabletop conferencing device in the enabled state while presence is detected in the monitored area by the audio sensor, and switch to the sleep state when the audio sensor no longer detects presence in the monitored area.

32. A tabletop conferencing device comprising:
a display adapted to display conferencing information;
a passive infrared sensor adapted to generate a signal based on sensed infrared radiation in a field of view, wherein the field of view consists of a front of the display of the tabletop conferencing device;
an audio sensor adapted to generate a signal based on a detected sound within a monitored area, wherein the detected sound within the monitored area comprises at least one of sound emitted from at least one of a participant in the monitored area and sound emitted by the tabletop conferencing device of a distal participant;
at least one processor coupled to the passive infrared sensor and the audio sensor, the at least one processor adapted to:
while the tabletop conferencing device is in a sleep state, switch the tabletop conferencing device to an enabled state upon receiving a signal from the passive infrared sensor;
while the tabletop conference device is in the enabled state, maintain the tabletop conferencing device in the enabled state upon receiving signals from the audio sensor;
while the tabletop conferencing device is in the enabled state, switch the tabletop conferencing device to the sleep state when the audio sensor does not detect presence in the monitored area.

33. A method of switching a tabletop conferencing device between a sleep state and an enabled state comprising the steps of:
generating at least one signal by a passive infrared sensor based on sensed infrared radiation in a field of view, wherein the field of view consists of a front of a display of the tabletop conferencing device;
generating at least one signal by an audio sensor based on detecting sound within a monitored are, wherein the detected sound within the monitored area comprises at least one of sound emitted from at least one of a participant in the monitored area and sound emitted by the tabletop conferencing device of a distal participant;
maintaining the tabletop conferencing device in the sleep state until receiving a signal from the passive infrared sensor;
in response to receiving the signal from the passive infrared sensor while in the sleep state, switching the tabletop conferencing device from the sleep state to an enabled state;
maintaining the tabletop conferencing device in the enabled state while receiving signals from the audio sensor; and
in response to no longer receiving signals from the audio sensor while in the enabled state, switching the tabletop conferencing device to the sleep state.
